(19) United States
(12) Patent Application Publication
(10) Pub. No.: US 2007/0086308 A1
(43) Pub. Date: Apr. 19, 2007

(54) Systems and methods for imaging

(76) Inventors: Makarand P. Gore, Corvallis, OR (US); Andrew L. Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/250,319

(22) Filed: Oct. 13, 2005

(51) Int. Cl. G11B 7/00

(52) U.S. Cl. 369/108

(57) ABSTRACT

An optical disc comprises a data layer defining a data side of the disc, the data layer being writable or readable with a data laser tuned to a first wavelength, and an imaging layer on the data side of the disc, the imaging layer comprising a colorformer and a developer.

### BACKGROUND

Materials that produce color change upon stimulation with energy such as light or heat may have possible applications in imaging. For example, such materials may be useful in allowing the laser labeling and imaging of optical discs such as CDs, DVDs, and blue laser discs. Many optical discs consist of a data side and a labeling side. One method of performing laser labeling or imaging of an optical disc involves layering onto the label side of the disc an imaging composition that changes color upon the application of energy such as laser light and applying laser light imagewise to create the visible label or image. Examples of laser imageable compositions are shown in Published U.S. patent application Nos. 20040146812. However, some optical discs contain data on both sides. Thus, in some circumstances the visible labeling may interfere with the ability to write and/or read data, and the reading and/or writing of data may interfere with the labeling. For example, the act of visibly labeling the data side of the optical disc may adversely affect the data layer (e.g., make undesirable marks on the data layer). Likewise, the act of writing or reading data in the data layer may adversely affect the labeling layer (e.g., make undesirable visible marks on the labeling layer). Additionally, the labeling layer may adversely interfere with the ability to read the data layer. In addition, it may be desirable to visibly label both sides of an optical disc for aesthetic reasons. Therefore, it may be advantageous to create compositions, methods, and systems for visibly labeling the side of an optical disc that contains data while allowing the data portion of the disc to remain data writeable and/or data readable.

### SUMMARY

Disclosed herein are imaging systems for producing images on a data side of an optical disc and imaging materials that may be coated onto a data side of an optical disc.

### BRIEF DESCRIPTION OF THE DRAWINGS

For a detailed description of embodiments of the invention, reference will now be made to the accompanying drawings in which:

FIGS. 1(A)-(C) are schematic drawings of a system in accordance with embodiments of the present invention, in which (A) illustrates the production of visible and machine-readable marks on the data side of the medium; (B) illustrates the medium of (A) in which the imageable layer has been bleached, and (C) illustrates the production of a machine-readable mark through the visible mark and imaging layer.

FIG. 2 shows a spectrum of a dye useful in labeling magenta image, and data reading and recording a 780 nm LASER in accordance with examples of the present invention.

### NOTATION AND NOMENCLATURE

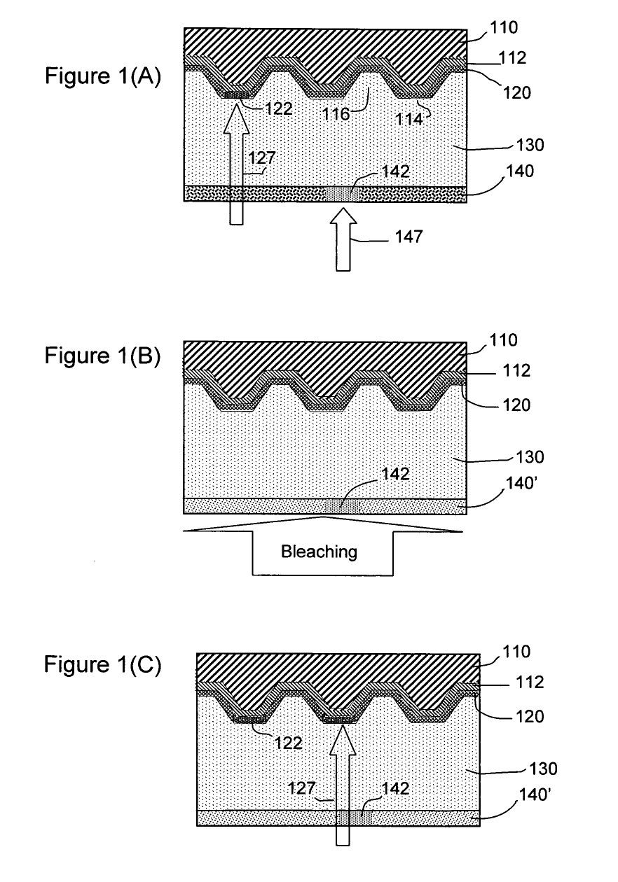

Certain terms are used throughout the following description and claims to refer to particular system components. As one skilled in the art will appreciate, companies may refer to components by different names. This document does not intend to distinguish between components that differ in name but not function. In the following discussion and in the claims, the terms “including” and “comprising” are used in an open-ended fashion, and thus should be interpreted to mean “including, but not limited to . . . ” The term “leuco dye” is a color forming substance which is colorless or one color in a non-activated state and produces or changes color in an activated state. As used herein, the term “activator” is a substance which reacts with a leuco dye and causing the leuco dye to alter its chemical structure and change or acquire color. By way of example only, activators may be phenolic or other proton donating species which can effect this change. The term “antenna” means any radiation-absorbing compound the antenna readily absorbs a desired specific wavelength of the marking radiation. The term “data layer” means the layer of an optical disc that contains machine-readable data. A data label may be readable only (i.e., the data is prewritten) or it may be both writeable and readable (e.g., a CD-R/RW or DVD±R/RW). The term “imaging layer” refers to the layer of an optical disc that may be labeled with visible images. Non-exclusive examples of imaging layers are disclosed in Published U.S. Patent Application No. 20040146812. It is not necessary that the data layer and the imaging layer be separate, although they may be. The compositions necessary for labeling may be contained in the same or separate layers as the compositions necessary for holding data. When a first layer is described as being “on” a second layer, it is meant that radiation must pass through the first layer before contacting the second layer. By way of example only, layer 112 of FIG. 1 is “on” layer 110, regardless of the orientation of the optical disc 100.

### DETAILED DESCRIPTION

The following discussion is directed to various embodiments of the invention. The embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the invention include coatings that may result in visible marking on a data side of an optical disc while the data layer of the disc remains readable and/or writeable. Further embodiments include optical discs which may be visibly labeled, data written, and data read on the same side without either operation interfering with the ability to perform the other.

The data readable/writeable layer may comprise prerecorded data (e.g., a prerecorded music CD) or may comprise a material suitable for data writing (e.g., CD-R/RW or DVD±R/RW). Presently, video data CDs use 780 nm dye and the DVDs use a 650 nm dye in the recording layer. Regardless, the present systems allow a visible image to be formed on the data side of the optical disc.

In order for the imaging not to interfere with the reading/writing operation, it may be necessary that the imaging layer consist of materials that: (a) can create an image by a method that does not undesirably alter the data layer such that the writeability and/or readability of the data layer is affected; (b) can create an image that will not be adversely affected when the data layer is read and/or written; and (c) will not themselves adversely affect the readability/writeability of the data layer.

Thus, for example, if the mark is to be on the data side of the disc, it must not prevent the reading and/or the writing of the data layer of the disc and the act of making the mark must not adversely affect the ability to read or write onto the disc. In addition, if the data layer is beneath or behind the labeling layer, the data laser that reads the data layer must be able to penetrate the labeling layer to effectively read the data without adversely affecting the label. Likewise, if the data layer is writeable, the laser must be able to record the data without interfering with the visible label (e.g., creating an undesirable mark). As discussed below, there are various ways to accomplish these goals.

One method in which this may be accomplished is if the visible label is “invisible” to the laser that reads and/or writes the data.

Referring now to FIG. 1(A), an optical disc 100 constructed in accordance with one embodiment of the invention includes a protective layer 110, a reflective layer 112, a dye layer 120 for data recording, a polymeric layer 130, and an imaging layer 140. Protective layer 110, reflective layer 112, dye layer 120, and polymeric layer 130 each may be constructed according to convention. Also according to convention, the facing surfaces of protective layer 110 and polymeric layer 130, which define the shape of reflective layer 112 and dye layer 120, may include a plurality of ridges 114, which may be defined a continuous spiraled groove 116. By way of example only, reflective layer 112 may comprise a metal film and polymeric layer 130 may comprise polycarbonate.

If the components that allow formation of visible marks, such as a dye and antenna or other thermochromic or photochromic materials, are transparent or substantially transparent to the data-writing radiation in both their inactivated and activated states, i.e., before and after production of a visible mark, it will not matter in which order the visible and machine-readable marks are produced. In FIG. 1, a data-writing laser 127 is shown producing a machine-readable mark 122 in dye layer 120. Prior to, concurrently with, or after the production of machine-readable mark 122, a visible mark 142 can be made using imaging radiation 147. Since dye layer 120 and imaging layer 140 are activated by different wavelengths in one embodiment, they function independently of each other and can be activated separately and in any order.

With respect to imaging layer 140, the materials used to produce color change upon stimulation by energy may include a color-former such as a fluoran leuco dye, an activator such as sulphonylphenol, and a radiation absorber tuned to the image-writing radiation.

In some embodiments, including that shown in FIG. 1, these are dispersed in a matrix such as radiation-curable acrylate oligomers and monomers and applied to polymeric layer. In other embodiments (not shown), they may be included in polymeric layer 130 itself, eliminating the need for a distinct imaging layer 140.

Either the leuco dye or the activator may be substantially insoluble in the matrix at ambient conditions. An efficient radiation energy absorber that functions to absorb energy and deliver it to the reactants is also present in this coating. To form a visible image, energy may be applied by way of, for example, a laser or infrared light. Upon application of the energy, either the activator, the color-former, or both may become heated and mix, which causes the color-former to become activated, resulting in a visible mark.

Still referring to FIG. 1(A), when it is desired to form a visible mark on the data side of optical medium 100, radiation 147 having a wavelength corresponding to the absorption wavelength of the antenna in imaging layer 140 is directed image-wise at the surface. The radiation is absorbed, causing localized heating, which in turn produces a visible mark 142 in imaging layer 140.

As mentioned above, in one method of practice of this invention, the antenna in the imageable coating may have no significant absorption in the wavelength of light that writes and/or reads the data in the data layer. For example, the antenna may absorb radiation of about 405 nm and the data layer may be read and/or written by a laser with wavelength of about 780 nm. Additionally, the color formed in the imaging layer should have no significant absorption in the wavelength used to read and/or write on the data layer. For example, suitable absorbers with orthogonal absorption may be chosen from a 405, 780 or 650 nm band, where the absorption of the imaging band and the color formed therein are different from that of the data writing band.

Examples of suitable absorbers for use as the “antenna” in imaging layer 140 include, but are not limited to 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene]-2-(phenylthio)-1-cyclohexen-1-yl]ethenyl]-3,3-dimethyl-1-propylindolium perchlorate; and mixtures thereof.

Alternatively, the radiation antenna can be an inorganic compound, such as ferric oxide, carbon black, selenium, or the like. Polymethine dyes or derivatives thereof such as a pyrimidinetrione-cyclopentylidene, squarylium dyes such as guaiazulenyl dyes, croconium dyes, or mixtures thereof can also be used in the present system and method. Suitable pyrimidinetrione-cyclopentylidene infrared antennae include, for example, 2,4,6(1H,3H,5H)-pyrimidinetrione 5-[2,5-bis[(1,3-dihydro-1,1,3-dimethyl-2H-indol-2-ylidene)ethylidene]cyclopentylidene]-1,3-dimethyl-(9Cl) (S0322 available from Few Chemicals, Germany).

Further, the radiation antenna can be selected for optimization of the color-forming composition in a wavelength range from about 600 nm to about 720 nm, such as about 650 nm. Non-limiting examples of suitable radiation antennae for use in this range of wavelengths can include indocyanine dyes such as 3H-indolium,2-[5-(1,3-dihydro-3,3-dimethyl-1-propyl-2H-indol-2-ylidene)-1,3-pentadienyl]-3,3-dimethyl-1-propyl-,iodide) (Dye 724 λmax 642 nm), 3H-indolium,1-butyl-2-[5-(1-butyl-1,3-dihydro-3,3-dimethyl-2H-indol-2-ylidene)-1,3-pentadienyl]-3,3-dimethyl-,perchlorate (Dye 683 λmax 642 nm), and phenoxazine derivatives such as phenoxazin-5-ium,3,7-bis(diethylamino)-,perchlorate (oxazine 1 λₘₐₓ=645 nm). Phthalocyanine dyes having a λmax of about the desired development wavelength can also be used such as silicon 2,3-napthalocyanine bis(trihexylsilyloxide) and matrix soluble derivatives of 2,3-napthalocyanine (both commercially available from Aldrich Chemical); matrix soluble derivatives of silicon phthalocyanine (as described in Rodgers, A. J. et al., 107 J. Phys. Chem. A 3503-3514, May 8, 2003), and matrix soluble derivatives of benzophthalocyanines (as described in Aoudia, Mohamed, 119 J. Am. Chem. Soc. 6029-6039, Jul. 2, 1997); phthalocyanine compounds such as those described in U.S. Pat. Nos. 6,015,896 and 6,025,486, which are each incorporated herein by reference; and Cirrus 715 (a phthalocyanine dye available from Avecia, Manchester, England having a λₘₐₓ=806 nm).

In still other embodiments, laser light having blue and indigo wavelengths from about 200 nm to about 600 nm can be used to develop the color forming compositions. Therefore, color forming compositions may be selected for use in devices that emit wavelengths within this range. Recently developed commercial lasers found in certain DVD and laser disk recording equipment provide for energy at a wavelength of about 405 nm. Thus, the compositions discussed herein using appropriate radiation antennae can be suited for use with components that are already available on the market or are readily modified to accomplish imaging. Radiation antennae that can be useful for optimization in the blue (˜405 nm) and indigo wavelengths can include, but are not limited to, aluminum quinoline complexes, porphyrins, porphins, and mixtures or derivatives thereof. Non-limiting specific examples of suitable radiation antenna can include 1-(2-chloro-5-sulfophenyl)-3-methyl-4-(4-sulfophenyl)azo-2-pyrazolin-5-one disodium salt (λₘₐₓ=400 nm); ethyl 7-diethylaminocoumarin-3-carboxylate (λₘₐₓ=418 nm); 3,3′-diethylthiacyanine ethylsulfate (λₘₐₓ=424 nm); 3-allyl-5-(3-ethyl-4-methyl-2-thiazolinylidene) rhodanine (λₘₐₓ=430 nm) (each available from Organica Feinchemie GmbH Wolfen), and mixtures thereof.

Non-limiting specific examples of suitable aluminum quinoline complexes can include tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1,2-d]1,3-dithiole, all available from Syntec GmbH, Wolfen, Germany.

Non-limiting examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange (CAS 2243-76-7), Merthyl Yellow (CAS 60-11-7), 4-phenylazoaniline (CAS 60-09-3), Alcian Yellow (CAS 61968-76-1), available from Aldrich chemical company, and mixtures thereof.

Referring now to FIGS. 1(B) and 1(C), in other embodiments, it may be desirable to produce images in the imaging layer using the same laser that reads and/or writes the data layer. In these embodiments, it is necessary that the image-forming materials absorb light at the wavelength of the data-writing laser, rather than being transparent to it. Thus, in these embodiments, production of visible and machine-readable marks may be carried out by first producing the visible marks, then “bleaching” the antenna in the imaging layer after the image is written, and then producing the machine-readable marks. In FIGS. 1(B) and 1(C), the bleached imaging layer is illustrated by reference numeral 140′.

Before “bleaching,” the antenna in the imaging layer will absorb the incident radiation, simultaneously allowing the production of the visible mark(s) and preventing marking of the data layer. After bleaching, the antenna will no longer have significant absorbance in the wavelength of the laser used to read/write and write the image. The bleaching may occur by, for example, exposing the image to a different wavelength of light which may cause a change within the molecule. The molecular change may be such that the antenna no longer absorbs radiation in the range used to write and/or read the data layer. Thus, as illustrated in FIG. 1(C), subsequent writing on medium 100 with a data laser 127 is not affected by the presence of imaging layer 140 or image(s) 142. In these embodiments, as in those described above, the image-forming or color-forming compositions that allow production of visible marks can be dispersed in all or a portion of polymeric layer 130, rather than being provided in a separate layer 140.

The indocyanine class of compounds, for example 3H-indolium,2-[5-(1,3-dihydro-3,3-dimethyl-1-propyl-2H-indol-2-ylidene)-1,3-pentadienyl]-3,3-dimethyl-1-propyl-,iodide), bleach readily upon exposure to fluorescent light. Light having wavelengths between 200 and 450 nanometers may be particularly useful for bleaching imaging absorbers.

Leuco dyes suitable for use in accordance with the present invention include, but are not limited to leuco dyes such as fluoran leuco dyes and phthalide color formers as described in “The Chemistry and Applications of Leuco Dyes,” Muthyala, Ramiah, ed., Plenum Press (1997) (ISBN 0-306-45459-9). Embodiments may include almost any known leuco dye, including, but not limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)-4,5-diphenylimidazoles, indanones, leuco indamines, hydrozines, leuco indigoid dyes, amino-2,3-dihydroanthraquinones, tetrahalo-p, p′-biphenols, 2(p-hydroxyphenyl)-4,5-diphenylimidazoles, phenethylanilines, and mixtures thereof. In other embodiments, the leuco dye may comprise a fluoran, phthalide, aminotriarylmethane, or mixtures thereof. Additional examples of dyes include-Pink DCF CAS#29199-09-5; Orange-DCF, CAS#21934-68-9; Red-DCF CAS#26628-47-7; Vemmilion-DCF, CAS#117342-26-4; Bis(dimethyl)aminobenzoyl Phenothiazine, CAS# 1249-97-4; Green-DCF, CAS#34372-72-0; Chloroanilino Dibutylaminofluoran, CAS#82137-81-3; NC-Yello-3 CAS#36886-76-7; Copikem37, CAS#144190-25-0; Copikem3, CAS#22091-92-5.

Several non-limiting examples of suitable fluoran based leuco dyes may include 3-diethylamino-6-methyl-7-anilinofluorane, 3-(N-ethyl-p-toluidino)-6-methyl-7-anilinofluorane, 3-(N-ethyl-N-isoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(N-cyclohexyl-N-methylamino)-6-methyl-7-anilinofluorane, 3-diethylamino-7-(m-trifluoromethylanilino) fluorane, 3-dibutylamino-6-methyl-7-anilinofluorane, 3-diethylamino-6-chloro-7-anilinofluorane, 3-dibutylamino-7-(o-chloroanilino)fluorane, 3-diethylamino-7-(o-chloroanilino)fluorane, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofluranone, 4,5,6,7-tetrachloro-3, 3-bis[2-[4-(dimethylamino)phenyl]-2-(4-methoxyphenyl)ethenyl], and mixtures thereof. Aminotriarylmethane leuco dyes may also be used in the present invention such as tris (N,N-dimethylaminophenyl) methane (LCV); deutero-tris(N,N-dimethylaminophenyl)methane (D-LCV); tris(N,N-diethylaminophenyl)methane (LECV); deutero-tris(4-diethylaminolphenyl)methane methane (D-LECV); tris(N,N-di-n-propylaminophenyl) methane (LPCV); tris(N,N-din-butylaminophenyl)methane (LBCV); bis(4-diethylaminophenyl)-(4-diethylamino-2-methyl-phenyl) methane (LV-1); bis(4-diethylamino-2-methylphenyl)-(4-diethylamino-phenyl) methane (LV-2); tris(4-diethylamino-2-methylphenyl)methane (LV-3); deutero-bis(4-diethylaminophenyl)-(4-diethylamino-2-methylphenyl) methane (D-LV-1); deutero-bis(4-diethylamino-2-methylphenyl)(4-diethylaminophenyl)methane (D-LV-2); bis (4-diethylamino-2-methylphenyl) (3,4-diemethoxyphenyl)methane (LB-8); aminotriarylmethane leuco dyes having different alkyl substituents bonded to the amino moieties wherein each alkyl group is independently selected from C1-C4 alkyl; and aminotriaryl methane leuco dyes with any of the preceding named structures that are further substituted with one or more alkyl groups on the aryl rings wherein the latter alkyl groups are independently selected from C1-C3 alkyl.

According to one exemplary embodiment, the acidic developers present in the radiation curable polymer matrix may include a phenolic species capable of developing color when reacting with a leuco dye and soluble or partially soluble in the coating matrix phase. Suitable developers for use with the present exemplary system and method include, but are in no way limited to, acidic phenolic compounds such as, for example, Bis-Phenol A, p-Hydroxy Benzyl Benzoate, Bisphenol S (4,4-Dihydroxydiphenyl Sulfone), 2,4-Dihydroxydiphenyl Sulfone, Bis(4-hydroxy-3-allylphenyl) sulfone (Trade name —TG-SA), 4-Hydroxyphenyl-4′-isopropoxyphenyl sulfone (Trade name —D8). The acidic developer may be either completely or at least partially dissolved in the UV-curable matrix.

### EXAMPLE

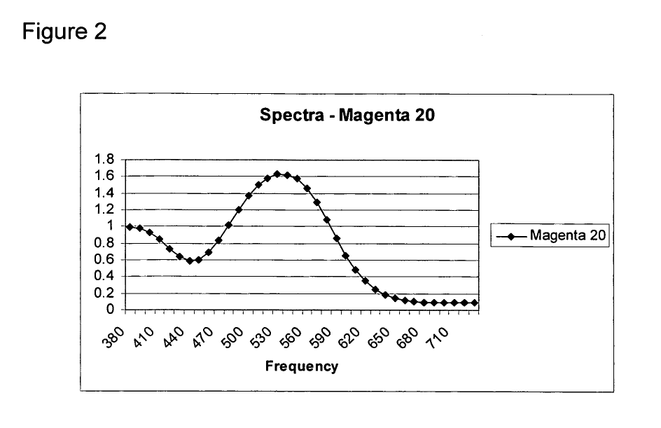

An imageable composition was coated onto the data side of a writeable compact disc. The composition comprised the specialty magenta 20, available from Noveon colorformer of Formula 1: 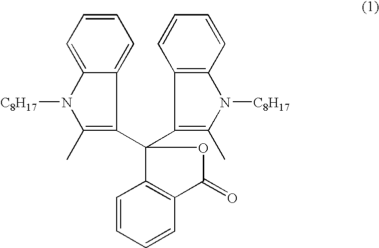
a phenolic activator, p-hydroxybenzyl benzoate, and IR780 (shown in Formula 2) 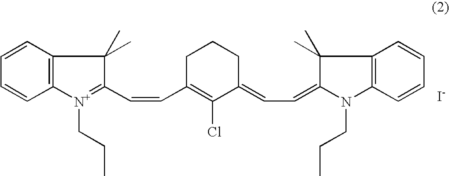
all within an acrylate matrix CDG000, available from Norcote, inc, Ohio. A visual image was recorded using a 780 nm laser. The disc was then exposed to radiation of 405 nm-450 nm using a dental lamp. The exposure to the dental lamp “bleached” the antenna such that there was no significant absorbance left at 780 nm. The data layer was then available for recording using 780 nm radiation. The color image formed in this example was magenta, and did not absorb significant radiation from the marking or data reading laser operating at 780 nm. The spectrum of the colored from of magenta 20 shows no absorbance of 780 nm radiation, as evident from the spectrum in FIG. 2.

Embodiments of the invention include coatings that result in clear marks and excellent image quality when marked with a 780 nm laser operating at 45 mW. The materials used to produce color change upon stimulation by energy may include a color-former such as a fluoran leuco dye and an activator such as sulphonylphenol dispersed in a matrix such as radiation-cured acrylate oligomers and monomers and applied to a substrate. In particular embodiments, either the leuco dye or the activator may be substantially insoluble in the matrix at ambient conditions. An efficient radiation energy absorber that functions to absorb energy and deliver it to the reactants is also present in this coating. Energy may then be applied by way of, for example, a laser or infrared light. Upon application of the energy, either the activator, the color-former, or both may become heated and mix which causes the color-former to become activated and a mark to be produced.

According to one exemplary embodiment, a radiation-curable polymer matrix phase may be chosen such that curing is initiated by a form of radiation that does not cause a color change of the color-former present in the coating, according to the present exemplary system and method. For example, the radiation-curable polymer matrix may be chosen such that the above-mentioned photo package initiates reactions for curing of the lacquer when exposed to a light having a different wavelength than that of the leuco dyes. Matrices based on cationic polymerization resins may require photoinitiators based on aromatic diazonium salts, aromatic halonium salts, aromatic sulfonium salts and metallocene compounds. A suitable lacquer or matrix may also include Nor-Cote CLCDG-1250A (a mixture of UV curable acrylate monomers and oligomers) which contains a photoinitiator (hydroxyl ketone) and organic solvent acrylates, such as, methyl methacrylate, hexyl methacrylate, beta-phenoxy ethyl acrylate, and hexamethylenediol diacrylate. Other suitable components for lacquers or matrices may include, but are not limited to, acrylated polyester oligomers, such as CN293 and CN294 as well as CN292 (low viscosity polyester acrylate oligomer), trimethylolpropane triacrylate commercially known as SR351, isodecyl acrylate commercially known as SR-395, and 2(2-ethoxyethoxy)ethyl acrylate commercially known as SR-256, all of which are available from Sartomer Co.

Embodiments of the present invention are applicable in systems comprising a processor and at least one laser coupled to the processor.

The above discussion is meant to be illustrative of the principles and various embodiments of the present invention. Numerous variations and modifications will become apparent to those skilled in the art once the above disclosure is fully appreciated. For example, the compositions and relative amounts of the color-forming agent, developer, and antenna, can all be varied, as can the wavelengths of the radiation used to produce the visible and machine-readable marks. It is intended that the following claims be interpreted to embrace all such variations and modifications. Similarly, unless explicitly so stated, the sequential recitation of steps in any claim is not intended to require that the steps be performed sequentially or that any step be completed before commencement of another step.

What is claimed is:

1. An optical disc comprising:
a data layer defining a data side of the disc, said data layer being writable or readable with a data laser tuned to a first wavelength; and
an imaging layer on the data side of the disc, said imaging layer comprising a color-former, and a developer.

2. The optical disc of claim 1, wherein said imaging layer further comprises an absorber.

3. The optical disc of claim 2 wherein the absorber in the imaging layer comprises an antenna tuned to absorb laser radiation of a second wavelength and said second wavelength is different from said first wavelength.

4. The optical disc of claim 1 wherein the imaging layer changes color when imaged and wherein the resulting color is substantially transparent to radiation at said first wavelength.

5. The optical disc of claim 1 wherein the imaging layer is bleached after imaging.

6. The optical disc of claim 2 wherein the absorber in the imaging layer comprises an antenna tuned to absorb laser radiation of a second wavelength that is the same as said first wavelength, wherein the imaging layer is bleached after imaging, and wherein the bleached imaging layer is substantially transparent to radiation at said first wavelength.

7. A method for labeling the data side of an optical disc, the method comprising:
a) providing a data layer on said data side, said data layer being writable or readable with radiation at a first wavelength;
b) providing an imaging layer on said data layer; and
c) applying a laser imagewise to the imaging layer so as to produce a mark that is substantially transparent to radiation at said first wavelength.

8. The method of claim 7, further comprising bleaching the imaging layer after step c).

9. The method of claim 7 wherein the imaging layer changes color when imaged and wherein the resulting color is substantially transparent to radiation at said first wavelength.

10. The method of claim 7 wherein the imaging layer comprises a color-former, a developer and an absorber.

11. The method of claim 10 wherein the absorber in the imaging layer comprises an antenna tuned to absorb laser radiation of a second wavelength and said second wavelength is different from said first wavelength.

12. The method of claim 10 wherein the absorber in the imaging layer comprises an antenna tuned to absorb laser radiation of a second wavelength that is the same as said first wavelength, wherein the imaging layer is bleached after imaging, and wherein the bleached imaging layer is substantially transparent to radiation at said first wavelength.

13. A method manufacturing an optical disc, comprising:
a) providing a substrate;
b) providing a data layer on said substrate, said data layer defining a data side of the disc and being writable or readable with radiation at a first wavelength;
c) providing an imaging layer on said data layer, said imaging layer including color-forming agents that produce visible marks upon irradiation at a second wavelength.

14. The method of claim 13 wherein the imaging layer changes color when imaged and wherein the resulting color is substantially transparent to radiation at said first wavelength.

15. The method of claim 13 wherein the imaging layer comprises a color-former, a developer and an absorber.

16. The method of claim 15 wherein the absorber in the imaging layer comprises an antenna tuned to absorb laser radiation of a second wavelength and said second wavelength is different from said first wavelength.

17. The method of claim 15 wherein the absorber in the imaging layer comprises an antenna tuned to absorb laser radiation of a second wavelength that is the same as said first wavelength, wherein the imaging layer is bleachable, and wherein the bleached imaging layer is substantially transparent to radiation at said first wavelength.

18. A system, comprising:
a processor;
a laser coupled to said processor;
a data storage medium including:
a data layer defining a data side of the disc, said data layer being writable or readable with a data laser tuned to a first wavelength; and
an imaging layer on the data side of the disc, said imaging layer comprising a color-former, a developer and an absorber.

19. The system of claim 18 wherein the absorber in the imaging layer comprises an antenna tuned to absorb laser radiation of a second wavelength and said second wavelength is different from said first wavelength.

20. The system of claim 18 wherein the imaging layer changes color when imaged and wherein the resulting color is substantially transparent to radiation at said first wavelength.

21. The system of claim 18 wherein the absorber in the imaging layer comprises an antenna tuned to absorb laser radiation of a second wavelength that is the same as said first wavelength, wherein the imaging layer is bleachable, and wherein the bleached imaging layer is substantially transparent to radiation at said first wavelength.
